(19) United States
(12) Patent Application Publication
(10) Pub. No.: US 2017/0073211 A1
(43) Pub. Date: Mar. 16, 2017

(54) SYSTEM AND FUEL NOZZLE FOR VEHICLE REFUELING

(71) Applicant: Purple Services, Inc., .Beverly Hills, CA (US)

(72) Inventors: Jason Wilson, Los Angeles, CA (US); Jean-Pierre Hubschman, Beverly Hills, CA (US); Bruno Uzzan, Beverly Hills, CA (US)

(73) Assignee: Purple Services, Inc., Beverly Hills, CA (US)

(21) Appl. No.: 14/852,688

(22) Filed: Sep. 14, 2015

(51) Int. Cl. B67D 7/04; G05B 15/02

(52) U.S. Cl. CPC B67D 7/04; G05B 15/02

(57) ABSTRACT

Embodiments of the present invention provide a system and associated smart fuel nozzle for improved fuel delivery to a vehicle. In particular, the smart fuel nozzle which can be in communication with a network including one or more of a fuel service provider, a courier's smart device, an user's device having an App, and in some embodiments, a vehicle's onboard computer/associated smart device. According to some aspects, the smart fuel nozzle can be used for controlled and monitored fuel delivery by a courier at the vehicle's location. According to some aspects, the ability to monitor the fuel being delivered can ensure proper delivery, quality of fuel, safe delivery, and automated order processing and/or confirmation.

### FIELD OF THE INVENTION

The present invention relates generally to the field of vehicle refueling components, and more particularly to systems and an associated fuel nozzle device that can be used to enable secure and controlled refueling of a vehicle.

### BACKGROUND OF THE INVENTION

Fueling consumer vehicles can be a time consuming and labor intensive practice for the vehicle user. The current practice is for the user to (1) monitor the vehicle fuel level; (2) determine a low fuel condition; (3) locate a fueling station; (4) purchase fuel; (5) gain access to the fuel tank; and (6) manually service the fuel tank.

Other previously user labor intensive services have been streamlined using networked systems and smart phone technology. As an example, car service procurement typically requires the user to determine the need for a car, locate a car services' contact information, determine and communicate the desired pickup location, negotiate the type and amount of payment at the end of the service, and pay. This process has been streamlined to the point where the user simply launches a smart phone application and pushes a button to request the car service. The phone determines the location of pickup which is utilized by the service to locate a nearby and available driver in the area and direct the driver to the corresponding pickup location. At the end of the service the payment to the driver is automatically taken care of by the service provider based on previous payment information provided by the user and a detailed receipt can be sent to the user.

This type of service streamlining is also desirable to enable fuel delivery services. One could consider a somewhat parallel approach to the driver procurement streamlining above. Similarly, for example, a smart phone App could allow a user to request fuel service at the touch of a button. The smart phone App would determine the location of the phone and transmit a request for fuel delivery to a fueling service. The fueling service would arrive at the location of the phone to service the vehicle fuel needs. Payment could also be handled similarly to the taxi procurement applications. However, to enable this in a way that is useful, various additional requirements that are specific to fuel delivery must be accounted for and new systems and/or devices must be developed for this type of delivery service to function in a practical and useful way for the everyday consumer. For example, limited fuel service exists in some specific industries like construction or road side assistance. In those industries a fuel courier transports fuel to a location near the vehicle needing fuel and a person in the location (e.g. owner or driver of the vehicle) receives the fuel and provides delivery verification. This limitation takes away from the convenience of the service, at least in part, because the person must wait to receive the fuel, identify to the courier the vehicle needing fuel and/or, in some events, dispense the fuel himself/herself out of a conventional container which can result in some hazards. In addition, it is difficult and impractical for the requester to verify that the amount of fuel purchased was actually delivered and dispensed in the vehicle's fuel tank, that the fuel was not altered by the courier before it was dispensed (e.g. diluted), and that it is of the quality purchased (e.g. octane rating, etc.), due to the typo of service.

In view of the foregoing, new devices and systems are highly desirable in order to have a smart phone based fuel delivery service that works at the consumer level and in a practical, safe, and cost effective way. In particular, a system that can provide controlled delivery of fuel without requiring the customer, or a customer's representative, to be present at the time of delivery.

### SUMMARY OF THE INVENTION

The foregoing needs are met, to a great extent, by the present invention, wherein in some aspects of embodiments of the invention are intended to address one or more of the above noted fundamental problems associated with delivery of fuel to consumer vehicles in a controlled manner. More specifically, one or more of the various aspects of the present invention enable the ability of a system for controlled fuel delivery service to (1) receive notification of an intended vehicle that requires fuel service; (2) determine the proximity of a filling smart fuel nozzle to a correct vehicle and the vehicle's fuel tank filling tube; (3) allow controlled fuel filling only when the smart fuel nozzle is in an acceptable proximity to the correct vehicle fuel filling tube; and (4) automatically generate fueling event data and transmit it to the customer and fuel filling service computers. By the ability of the system to recognize, address and enable at least the aforementioned items (1)-(4), the system can provide consumer assurance that the service they paid for occurred and to provide them with detailed information about the service performed, allow customers to assess their satisfaction with the fueling service the company is providing, and allow the fuel service company to keep objective book keeping records, thus allowing the fuel service provider to run the company more efficiently, grow customer base, and keep the couriers honest. By the present invention, one or more of these problems can be addressed by a smart fueling pump/nozzle. By smart it is meant that the device is an electronic device, generally connected to other devices or networks via different protocols such as Bluetooth, NFC, WiFi, Cellular Network, RFID, etc., that as a result of its architecture components and their configuration, can operate to some extent interactively and autonomously for the controlled delivery of fuel.

According to some aspects of the disclosure, a system for refueling of a vehicle parked outside of a gas station is disclosed. The system includes a vehicle identification tag used to generate a vehicle confirmation signal, a portable fuel container (for transporting a volume of fuel to the vehicle's location) having a fuel outlet used to dispense fuel into a fuel tank of the vehicle, and a smart fuel nozzle in fluid communication with the container's fuel outlet, the smart fuel nozzle including a controller in communication with a communication device, a flow meter, and a valve/fuel regulator. The controller with the communication device are configured to transmit the confirmation signal and process a fuel request to regulate, via the flow meter and the valve/fuel regulator, an amount of fuel dispensed into the fuel tank from the portable fuel container.

According to additional aspects, the system for refueling of a vehicle can include: a near field identification tag fixed near a vehicle's fuel tank, a fuel container having a fuel outlet used to dispense fuel into a fuel tank of the vehicle, and a smart fuel nozzle in fluid communication with the container's fuel outlet. The smart fuel nozzle can include a flow meter, a valve/fuel regulator, and a near field communication reader in communication with a controller. The near field communication reader can be positioned in/on the smart fuel nozzle such that it can read the near field identification tag fixed near the vehicle's fuel tank when at least a portion of the smart fuel nozzle is inserted into the vehicle's fuel tank for fuel dispensing, and the controller is configured to process a fuel request to regulate, via the flow meter and the valve/fuel regulator, an amount of fuel dispensed into the fuel tank from the fuel container upon the vehicle confirmation signal.

In yet additional aspects, a smart fuel nozzle for refueling of a vehicle parked outside of a gas station that can form part of the aforementioned system is disclosed. The smart fuel nozzle including: a coupler for attaching the smart fuel nozzle to a portable fuel container, for transporting a volume of fuel to the vehicle's location, having a fuel outlet used to dispense fuel into a fuel tank of the vehicle; and a controller in communication with a near field communication device, a flow meter, and a valve/fuel regulator. The controller with the near field communication device can be configured to receive a vehicle identification code from a near field communication tag and process a fuel request to regulate, via the flow meter and the valve/fuel regulator, an amount of fuel dispensed into the fuel tank corresponding to the vehicle identification code and the fuel request from the portable fuel container.

In some embodiments, the near field communication tag is fixed near the vehicle's fuel tank and a communication device of the smart fuel nozzle is a near field communication reader positioned in the smart fuel nozzle such that it can read the near field identification tag when at least a portion of the smart fuel nozzle is inserted into the vehicle's fuel tank for fuel dispensing. A controller can permit actuation of the valve/fuel regulator to allow dispensing of fuel after the near field communication reader scans the near field communication tag and confirms the vehicle matches a vehicle in the fuel request. This essentially can serve as a means to control the delivery so that fuel paid for by a customer can only be delivered to the vehicle for which it is requested. The controller however may also be programmed to override this delivery control when it receives a signal directly for the service provider (i.e. direct verification) that the correct car is located and the courier is trusted to dispense a limited volume of fuel matching that of the request.

In some embodiments, the smart fuel nozzle can also include a global positioning system (GPS) in communication with the controller for determining and tracking the fuel tanks' location at all times. Alternatively or in addition to, the controller and communication device of the smart fuel nozzle may communicate with a smartphone of the courier to transmit information that includes location data from the smartphone's GPS, fuel request data, and the such. According to some aspects, in addition to regulating the fueling itself with respect to where the fuel is dispensed, the volume of fuel dispensed can also be measured by the flow meter. By measuring the volume dispenses, the volume dispensed can be recorded and tracked. This can be important, for example, to allow a delivery courier to complete a partial fuel delivery because the amount of gas the courier has at the time the order is received is insufficient to the one in the fuel request order and issue a credit to the user. By means of another example, by knowing exactly how much gasoline each courier has in a fuel container, only those couriers that can fulfill a volume of fuel in an order are considered for the delivery. This in essence can increase processing speeds and enable better service.

There has thus been outlined, rather broadly, certain aspects of the invention in order that the detailed description thereof herein may be better understood, and in order that the present contribution to the art may be better appreciated. There are, of course, additional aspects of the invention that will be described below and which will also form the subject matter of the claims appended hereto.

In this respect, before explaining at least one aspects of the invention in detail, it is to be understood that the invention is not limited in its application to the details of construction and to the arrangements of the components set forth in the following description or illustrated in the drawings. The invention is capable of aspects in addition to those described and of being practiced and carried out in various ways. Also, it is to be understood that the phraseology and terminology employed herein, as well as the abstract, are for the purpose of description and should not be regarded as limiting,

As such those skilled in the art will appreciate that the conception upon which this disclosure is based may readily be utilized as a basis for the designing of other structures, methods and systems for carrying out the several purposes of the invention. It is important, therefore, that the claims be regarded as including such equivalent constructions insofar as they do not depart from the spirit and scope of the invention.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention.

FIG. 1 provides a schematic illustrating exemplary system components and interconnections between components according to aspects of the disclosure;

FIG. 2 provides a perspective view of a vehicle being refueled according to aspects of the present disclosure;

FIG. 3 provides a flow diagram of the microprocessor logic for an exemplary fueling event according to aspects of the disclosure; and

FIG. 4 provides exemplary method steps that can be carried out by the fuel service provider incorporating the smart fuel nozzle of the system according to aspects of the present disclosure.

The present invention is further described in the detailed description that follows.

### DETAILED DESCRIPTION OF THE INVENTION

The present disclosure provides for a system in which, in some embodiments, one or more of these problems can be addressed by smart fueling pump/nozzle. By smart it is meant that the device is an electronic device, generally connected to other devices or networks via different protocols such as Bluetooth, NFC, WiFi, Cellular Network, RFID, etc., that can operate to some extent interactively and autonomously for the controlled delivery of fuel. In accordance with the disclosure, the use of the described system and associated smart fuel nozzle embodiments and related aspects can enable controlled and streamlined/automated fueling service to a consumer,

More specifically, the smart fueling pump/nozzle (the “smart fuel nozzle”) is described as forming part of a system that can perform all or some of: pumps fuel from a fuel container into a vehicle fuel tank; records fueling event history like gallons pumped, time, location and near field data tags; regulate fuel dispensing based on data gathered and check systems; transmits data to a fuel service company; and transmits data to the vehicle owner. According to some aspects, data transmitted to the fuel service company includes a request with pertinent information relating to the fuel service including vehicle location, fuel type, estimated fuel required, user account information, window of fueling opportunity and the like. In some embodiments, the smart fuel nozzle device may communicate with one or more of the vehicles on board sensors through typical sensor interfaces (e.g. ODD II); with a wireless smartphone device; a laptop computer; and/or a smart gas cap as disclosed in Applicant's Co-pending U.S. patent application Ser. No. 14/731,320 filed on Jun. 4, 2015, Titled “Device and System for Automotive Refueling” the contents of which are hereby incorporated by reference.

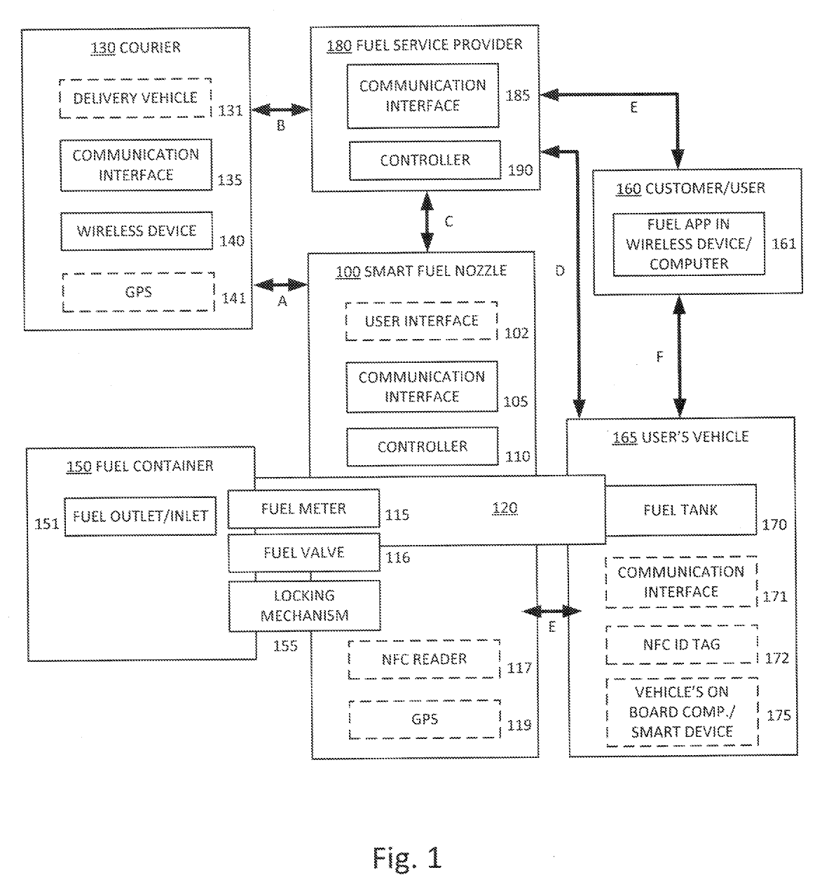

Referring now to FIG. 1, a schematic illustrating exemplary system components and interconnections between components is shown—including the smart fuel nozzle 100. In particular, the exemplary system architecture illustrates the smart fuel nozzle 100 which is in communication with a wireless device 140 of a courier 130 that is able to deliver fuel to the user's vehicle 165 according to aspects of the disclosure. In some embodiments, the smartphone device 140 of the courier 130 may be substituted, or function in addition to, a laptop computer, handheld device, a tablet, a personal digital assistant (PDA) and the such. Communication A between the smartphone device 140 and/or digital device and the smart fuel nozzle 100 may be wireless between communication interfaces 102 and 135, respectively. Communication A can be preferably wireless communication but, in some embodiments, may also include, or alternatively be, wired-based communication.

Smart fuel nozzle 100 can include a microcontroller/controller 110 capable of executing software code stored in a memory (not shown) and in logical communication with at least the communication interface 105 and a user interface 102. User interface 102 can include, for example, one or more of a touch screen display, a lever for dispensing gas, a keyboard, mouse, trackball, voice recognition system, and the such. In some embodiments, the user interface 102 of the smart fuel nozzle 100 can be the wireless device 140 of the courier 130.

According to some aspects of the disclosure, the smart fuel nozzle 100 includes a locking mechanism 155 that attaches the smart fuel nozzle 100 to a fuel container 150 for fuel delivery. Fuel dispensing may he done by the fuel container 150 with the use of pumping mechanism (not shown) and/or without a pumping mechanism, for example, by using a gravity pressure fuel container. Locking mechanism 155 may be a mechanical lock fixing the smart fuel nozzle 100 and fluid path 120 to the fuel container's 150 fuel inlet/outlet 151. Alternatively, or in addition to the locking mechanism 155 may be/include a magnetic lock that can also be controlled by the controller 110 of the smart fuel nozzle 100. The locking mechanism 155 can allow for controlled access or dispensing to the fuel in/into the fuel tank 150 and it is not limited to the aforementioned. However, it is important that the locking mechanism 155 restricts unintended access to the fuel in the container. For example, controlled access may include when the fuel level is below a pre-determined level and the fuel container 150 needs to be filled up at a gas station. The locking mechanism 155 may also be unlocked, for example, for filling up the fuel container 150, upon/after receiving authorization from the central office of the fuel service provider 180 and/or in case of an emergency. Locking/unlocking may be done by the central office of the fuel service provider 180, with the use of a code obtained by the courier 130 from the fuel service provider 180, and/or a key.

According to additional aspects, the fluid path 120 may contain fuel meter 115 and/or fuel valve 116. “Fuel valve” 116 as used herein includes one or both of: (a) control valve working with power actuators, positioners and/or other accessories to ensure accurate control of fuel flow, and (b) a fuel flow regulator which may include, for example, a locking mechanism that prevents the fuel regulator from opening a path for fuel dispensing. (i.e., a fuel regulator, such as a lock preventing actuation of a lever/switch/button/knob used to move part on the fuel path for fuel dispensing, can be the fuel valve.)

The fuel meter 115 and valve 116 can be in communication with controller 110 so that fuel delivery and dispensing into the user's vehicle 165 can be controlled according to aspects of this disclosure. Other components of the smart fuel nozzle can additionally include a near field communication (NFC) reader 117, such as an RFID reader, and a global positioning system (GPS) 119, also in communication with the controller 110.

Fuel dispensing can he via the fluid path 120 to the user's vehicle 165 fuel tank 170 as controlled by the fuel valve 116 which is actuated by the controller 110 according to a verification signal, and in some embodiments, dependent on a fuel meter 115 reading. User's vehicle 165 may include a communication interface 171, vehicle's on board computer 175 (and/or smart device), a near field communication tag 172, such as an RFID tag including the vehicle identification, which may be a VIN number, license plate, and/or member ID determined by the fuel service provider 180. In some embodiments, the user's 160 smartphone/computer may be in communication with the fuel service provider 180. Communication E, and/or the vehicle's computer 175. Communication F, via App 161. Alternatively, or in addition to, the fuel service provider 180 may also be in communication with the vehicle's on board computer 175, as shown in communication D. The fuel service provider 180 operates one or more controller(s) 190 interconnected via a communication network and having a communication interface 185 for with one or more of the smart fuel nozzle 100 (communication C), the courier B (communication B), user (communication F), and user's vehicle 165 (communication D). According to some aspects, communication between the one or more entities can include, for example, wired data communication and/or wireless data communications including cellular data service, mobile satellite communications, wireless sensor networks, near field communications, a local area network (Bluetooth, Zugbee, etc.) and the such.

In some embodiments, data from different components, such as GPS, user interfaces, and/or sensors, may be shared/independent between devices, to allow for controlled delivery. Controlled fuel delivery is referred to as such because it serves the primary function of conveying fuel from a fuel container 150 to a vehicle 165 via fuel filler tube 120 in a regulated and safe manner by performing any and all necessary tasks such as anti-spill, vapor recovery, auto shut off, fuel metering, keeping container secure and restricting fuel access, and the like. For example, the courier 130 may receive a notification to deliver fuel via a smart phone App. 140 including details about the fueling service including, for example, vehicle type, vehicle location, vehicle ID, and fuel amount/type. Courier 130 transports fuel container 150 in a delivery vehicle 130. Once the fuel courier 130 arrives at the vehicle 165 and inserts the smart fuel nozzle 100 into the fuel filler tube of the fuel tank 170, the smart fuel nozzle 100 is put in a fueling mode by manipulating a physical user interface 102. As previously mentioned, the user interface 102 may be a touch screen, button, or typical trigger used in standard nozzles. However, in this case the actuator does not activate the pump/fuel valve 116 but notifies the microcontroller 110 that the smart fuel nozzle 100 is in a fueling position.

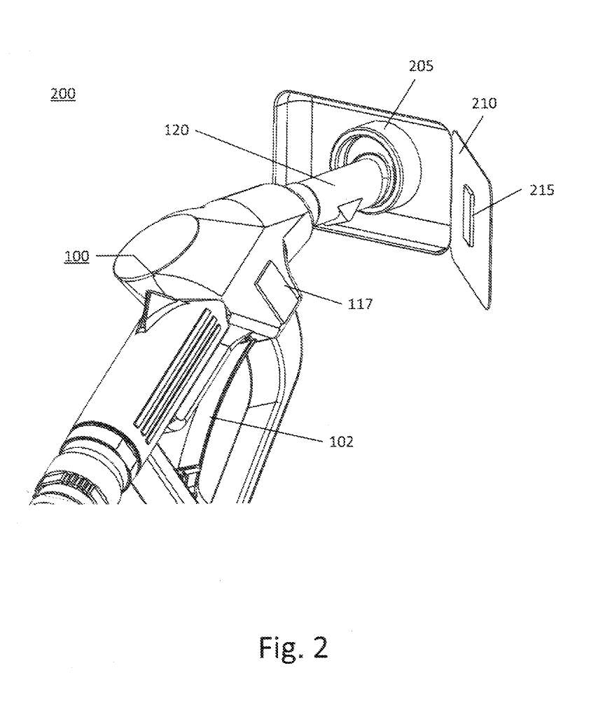

On in fuel mode, the smart fuel nozzle 100 detects if it is in the proximity of the correct vehicle. In some embodiments, this can be done using the NFC tag 172 (RFID Tag) installed on the vehicle 165. According to some aspects, the RFID tag 172 is positioned such that its reading ability's short range by NFC reader 117 can ensure that the smart fuel nozzle 100 is very close to the fuel tank 170 before fueling can be initiated and, in some embodiments, during fueling. For example, the RFID tag 122 can be a passive label embedded in a branding sticker with a read range of a few centimeters. This sticker can be adhered to the inside of the vehicle's gas tank as depicted in FIG. 2. In other embodiments the NFC tag 172 may be powered to allow for longer ranges such as feet or meters. By including this verification mechanism, fueling is restricted to when the smart fuel nozzle 100 is in proximity to the correct vehicle's fuel tank 170, verifying to the customer and fuel delivery company that the courier 130 indeed serviced the correct vehicle 165.

In some embodiments, during filling, the smart fuel nozzle 100 periodically checks for the RFID tag 172 ensuring that the smart fuel nozzle 100 hasn't been removed from the vehicle's fuel tank 170. In the case that the RFID tag 172 is not read by the RFID reader 117 during fueling, the controller 110 can shut off the fuel pump and/or notify the fuel service provider 180. This may be important since the RFID detection fail could be a result of the smart fuel nozzle 100 falling out of the fuel filler tube of the fuel tank 170, or the courier 130 filling an unauthorized vehicle/container during the fueling service. Upon successful completion of the fuel service, a fueling data log can be sent to the fuel service provider 180 and customer 160 including time, gallons delivered (verified by the fuel meter 115), and RFID read results.

Further, in some embodiments, as an added control, the smart fuel nozzle 100 may also check the location of the smart fuel nozzle 100, using the GPS 119/141, and compare it to the expected location of the vehicle 165 and/or courier 130. This can also help ensure that the fuel is delivered to the correct vehicle 155 in the location of the fuel request. Also with this control check, fueling may be shut off if the smart fuel nozzle 100 and/or courier 130 is not in the expected vicinity of the vehicle 165 based on GPS data.

According to yet additional aspects, in the case that the NFC ID tag read fails, the courier 130 may also have access to an override-option. In the case of an override, the fueling data log can be sent to the fueling service provider 180 and customer 160 along with notes about the failure (e.g. the RFID tag was damaged and replaced). Moreover, the override option may only be an option after the courier 130 has first contacted the fuel service provider 180 for authorization.

Referring now to FIG. 2, a perspective view of an exemplary vehicle being refueled is shown at 200. More specifically, the vehicle 165 is shown with the fueling door 210 open revealing the fueling door's inner surface. Attached to that surface can be the NFC ID tag 172 (e.g., RFID Tag 215). In a preferred embodiment this RFID tag 215 may be a 13.56 MHz type high frequency tag with a range from 10 cm to 1 m. In another embodiment, the RFID tag 215 may be a 902-928 MHz type ultra-high frequency tag with a range of 1-12 meters.

The smart fuel nozzle 100 is shown with fuel fluid path 120 inserted in the vehicle's fuel filler tube 205 leading to the fuel tank 170. Attached to the side of the smart fuel nozzle 100 is a NFC reader 117. The position and orientation of the smart fuel nozzle 100 and the fuel filler door 210 are such that the reader 117 and RFID tag 215 are within communication range when fueling should occur. As shown, the fuel door 210 opens to the right. For vehicles where the fuel door 210 opens to the left, the smart fuel nozzle 100 is equipped with a second antenna or movable antenna to read the opposite side. As previously described, in preferred embodiments the smart fuel nozzle can include a user interface 102, a communication interface 105, microprocessor/controller 110, the NFC reader 117, and GPS 119.

Referring now to FIG, 3, a flow diagram 300 of the microprocessor/controller logic for a fueling event is shown. More specifically, the microprocessor/controller decision steps to ensure that fuel can be delivered in a controlled and safe manner. Beginning at 301, the program (e.g. App) causes the controller to check for a fuel service request from the courier App or other external communication with the fuel service provider's dispatch center. When a customer requests fuel, the dispatch center sends a message to the courier's smart phone app alerting that a vehicle needs fueling. As part of the message, a vehicle location, vehicle identification, delivery time, fuel type and amount, is also transmitted. The courier's app and/or the fuel service provider may also communicate with the smart fuel nozzle the vehicle RFID tag information and vehicle location.

When the courier inserts the smart fuel nozzle in the vehicle's fuel filler tube and pulls the smart fuel nozzle dispense handle, the microprocessor reads this “button” change as a dispense event. Other dispense events could include touches on a smart fuel nozzle touch screen, communication from the courier app and the like.

At 305, once the smart fuel nozzle is in dispense mode it may activate the RFID tag reader and/or verify GPS location. If the correct tag and/or location is read, at 325, the smart fuel nozzle may dispense fuel. Correct tag may mean that the read tag identification information matches the tag identification information relayed to the smart fuel nozzle by the courier app/fuel service provider during the fuel service request step. Dispensing fuel means sending current to the fuel transfer pump/opening fuel valve to allow controlled flow/movement of the fuel from the fuel container to the vehicle's fuel tank.

In some embodiments, during dispensing the smart fuel nozzle periodically checks that the tag is still readable, meaning that the smart fuel nozzle is still inside the fuel tank's filler tube. At 330, the smart fuel nozzle also logs the volume of the fuel being delivered via a fuel meter (such as a flow meter) and other miscellaneous information like time, overflow events, and the like. When the RFID is damaged, and/or there is a malfunction, at 320, an override function can be activated. The override function requires, for example, additional logging in of data for fuel dispensing and/or permission from the fuel delivery service provider to allow dispensing without the RFID verification.

At 335, the smart fuel nozzle may terminate the fuel dispensing at 340 when a stop dispense fuel event is determined. The stop dispensing event 330 could happen, for example, when the smart fuel nozzle can no longer read the RFID tag, if an overflow condition is determined, or if the courier manually creates one via an HMI (e,g. releasing the dispense handle). After fueling is completed and dispensing is stopped at 340, the logged information can be transmitted to the courier's smart phone app for future use at 345. Uses may include verification to the customer that fueling occurred and data detailing the fueling events. Events can include, for example, the RFID to read, the GPS location coordinates of the smart fuel nozzle location, vehicle, and/or courier, the volume of fuel delivered, and the like. Also, in the event that there is a failure (e.g. RFID tag is damaged), the override option to dispense fuel without the automated regulation may also be logged and sent to the courier app as part of the data log.

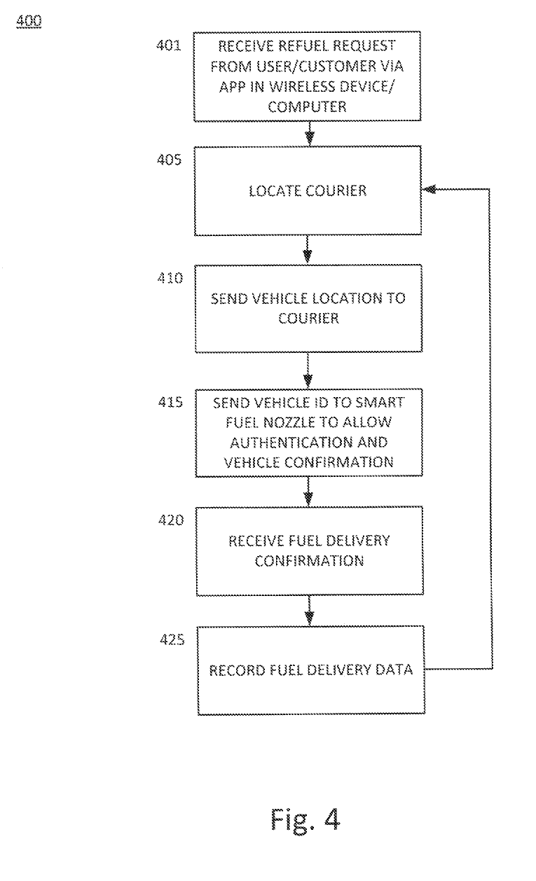

Referring now to FIG. 4, exemplary method steps that can be carried out by the fuel service provider incorporating the smart fuel nozzle of the system according to aspects of the disclosure are shown in flow diagram 400. In particular, the diagram 400 may help efficient delivery of fuel to users by selecting couriers that can best serve the user's vehicle. Beginning at 401, the fuel service provider receives a fuel request from an App installed in a user/customer's smartphone device or computer. The service provider then, at 405, locates a courier based on a location from a courier's GPS that is proximate to the location for the delivery, a fuel type available that matches a fuel type selected in the request, and/or an amount of fuel available in the fuel container of the courier. The type and/or amount of fuel available in the fuel container may be tracked from the fuel delivery data recorded in previous fuel dispending/delivery events at 425.

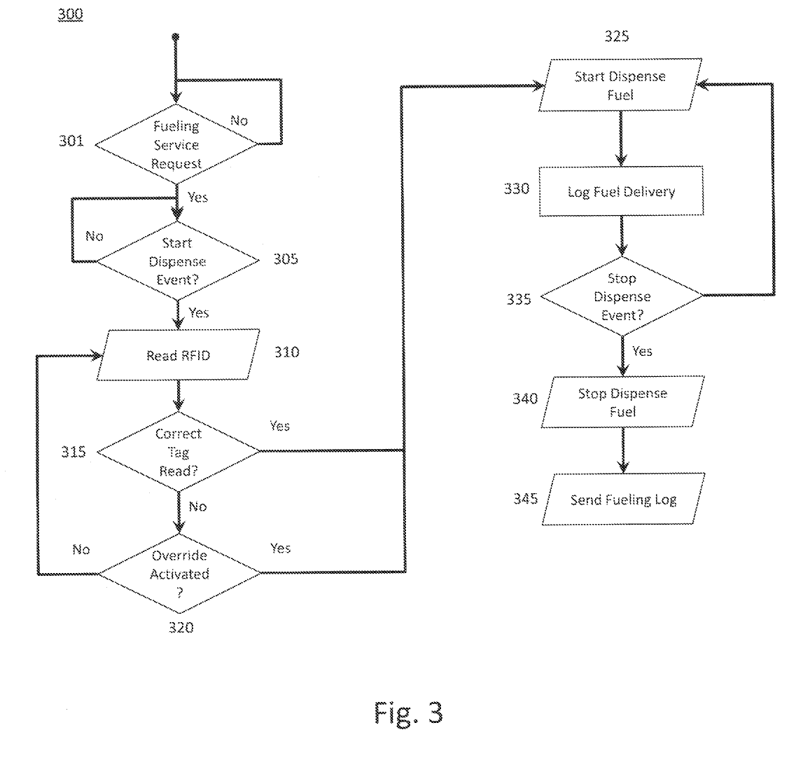

At 410, the location may be sent by the fuel service provider to the best courier available for the delivery. At 415, the vehicle ID is then sent, either by the courier's device and/or the fuel service provider, to the fuel nozzle for authentication and vehicle confirmation upon arrival of the courier at the location. Once fuel has been delivered, for example, as described in FIG. 3, the fuel delivery service's system receives a fuel delivery confirmation 420. All delivery data can be recorded, at 425, for analytics, optimization, courier performance, future orders, and the such.

The many features and advantages of the invention are apparent from the detailed specification, and thus, it is intended by the appended claims to cover all such features and advantages of the invention which fail within the true spirit and scope of the invention. Further, because numerous modifications and variations will readily occur to those skilled in the art, it is not desired to limit the invention to the exact construction and operation illustrated and described, and accordingly, all suitable modifications and equivalents may be resorted to, falling within the scope of the invention.

1 to 18. (canceled)

19. A system for refueling, the system comprising:
a vehicle identification tag used to identify a vehicle;
a portable fuel container, for transporting a volume of fuel to a location of the vehicle that is remote from a location of a gas station, the portable fuel container having a fuel outlet used to dispense fuel into a fuel tank of the vehicle; and
a smart fuel nozzle in fluid communication with the fuel outlet, the smart fuel nozzle including a controller in communication with a communication device and a flow meter,
wherein the controller is configured to:
process a fuel request, wherein the fuel request is initially received by a server such that the server identifies a plurality of selected couriers from a plurality of couriers, the identification of the plurality of selected couriers being based on at least one parameter, and
transmit, by the communication device, a confirmation signal.

20. The system of claim 19, wherein the smart fuel nozzle additionally comprises:
a valve to regulate an amount of fuel dispensed into the fuel tank from the portable fuel container.

21. The system of claim 20, wherein the vehicle identification tag is a near field communication tag that is fixed near the fuel tank.

22. The system of claim 21, wherein the communication device is a near field communication reader positioned in the smart fuel nozzle such that the communication device reads the near field communication tag when at least a portion of the smart fuel nozzle is inserted into the fuel tank for fuel dispensing.

23. The system of claim 22, wherein the controller is configured to permit actuation of the valve after generating the confirmation signal, wherein the confirmation signal is generated when the near field communication reader reads the near field communication tag and confirms the vehicle matches a vehicle in the fuel request.

24. The system of claim 23, wherein actuation of the valve is overridden by a restriction signal, the restriction signal received from a refueling provider via the communication device.

25. The system of claim 19, wherein the smart fuel nozzle additionally comprises:
a global positioning sensor in communication with the controller for determining and tracking the location of the vehicle.

26. (canceled)

27. A system for refueling, the system comprising:
a near field identification tag used to identify a vehicle at a location that is remote from a location of a gas station, the near field identification tag fixed near a fuel tank of the vehicle;
a fuel container having a fuel outlet used to dispense fuel into the fuel tank of the vehicle; and
a smart fuel nozzle in fluid communication with the fuel outlet, the smart fuel nozzle including a controller in communication with a flow meter, a fuel valve, and a near field communication reader,
wherein the near field communication reader is positioned in/on the smart fuel nozzle, such that the near field communication reader reads the near field identification tag when at least a portion of the smart fuel nozzle is inserted into the fuel tank of the vehicle for fuel dispensing, and
wherein the controller is configured to process a fuel request, wherein the fuel request is initially received by a server such that the server identifies a plurality of selected couriers from a plurality of couriers, the identification of the plurality of selected couriers being based on at least one parameter, and wherein processing the fuel request further includes:
regulating, via the flow meter and the fuel valve, an amount of fuel dispensed into the fuel tank of the vehicle from the fuel container upon the vehicle transmission of a confirmation signal and
communicating, via the controller, the amount of fuel dispensed into the fuel tank of the vehicle from the fuel container to at least one of the server, an on-board vehicle processor, and a wireless device.

28. The system of claim 27, wherein the fuel container is portable.

29. A smart fuel nozzle for refueling, the smart fuel nozzle comprising:
a coupler for attaching the smart fuel nozzle to a portable fuel container, for transporting a volume of fuel to a location of a vehicle that is remote from a location of a gas station, the portable fuel container having a fuel outlet used to dispense fuel into a fuel tank of the vehicle; and
a controller in communication with a near field communication device and a flow meter,
wherein the controller is configured to:
receive, by the near field communication device, a vehicle identification code from a near field communication tag, and
process a fuel request, wherein the fuel request is initially received by a server such that the server identifies a plurality of selected couriers from a plurality of couriers, the identification of the plurality of selected couriers being based on at least one parameter, and wherein processing the fuel request further includes:
monitoring, via the flow meter, an amount of fuel dispensed from the portable fuel container, and
communicating, via the controller, the amount of fuel dispensed into the fuel tank from the portable fuel container to at least one of the server, an on-board vehicle processor, and a wireless device.

30. The smart fuel nozzle of claim 29, additionally comprising:
a valve, controlled by the controller, to regulate the amount of fuel dispensed from the portable fuel container.

31. The smart fuel nozzle of claim 30, wherein the near field communication tag is fixed near the fuel tank, and wherein the near field communication device is positioned in the smart fuel nozzle such that it reads the near field communication tag when at least a portion of the smart fuel nozzle is inserted into the fuel tank for fuel dispensing.

32. The smart fuel nozzle of claim 31, wherein the controller is configured to permit actuation of the fuel valve after the near field communication reader scans the near field communication tag and confirms the vehicle matches a vehicle in the fuel request.

33. (canceled)

34. The smart fuel nozzle of claim 29, wherein the smart fuel nozzle additionally comprises:
a global positioning sensor in communication with the controller for determining and tracking the location of the vehicle.

35. (canceled)

36. The smart fuel nozzle of claim 29, additionally comprising:
a wireless communication device and configured with the controller to communicate data with a wireless smartphone.

37. The smart fuel nozzle of claim 36, wherein the fuel request is received by the wireless communication device, the fuel request including the vehicle identification code and the amount of fuel based on an input by a user via the wireless smartphone.

38. The smart fuel nozzle of claim 29, additionally comprising a fuel valve, wherein the fuel valve is a fuel regulator including a lock that is configured to prevent a courier from opening a fuel path for dispensing.

39. The system of claim 19, wherein the parameter for identifying the plurality of selected couriers is at least one of the location of the vehicle and a location of each courier of the plurality of selected couriers.

40. The system of claim 19, wherein the parameter for identifying the plurality of selected couriers is at least one of a time window for fueling, a required fuel type, and an estimated fuel amount.

41. The system of claim 19, wherein one of the plurality of selected couriers selects an order confirmation that the fuel request has been completed, and wherein the order confirmation is sent to at least one of the server, the on-board vehicle processor, and the wireless device.
